(19) United States
(12) Patent Application Publication
(10) Pub. No.: US 2008/0006268 A1
(43) Pub. Date: Jan. 10, 2008

(54) Helmet Having A Filter

(76) Inventor: David Hanlon, Arundel, ME (US)

Correspondence Address: CHRIS A. CASEIRO, VERRILL DANA, LLP, ONE PORTLAND SQUARE, PORTLAND, ME, 04112-0586, US

(21) Appl. No.: 11/456,121

(22) Filed: Jul. 7, 2006

(51) Int. Cl. A62B 17/04; A62B 7/10; A62B 18/02

(52) U.S. Cl. 128/201.25; 128/205.25; 128/201.22

(57) ABSTRACT

A protective helmet for wearing while riding an open-air vehicle, such as a motorcycle or all-terrain vehicle. In addition to protecting the head from being injured in a collision, the helmet prevents particles of dirt, dust and similar debris from reaching the face of the helmet wearer. The helmet includes one or more removable filters which cover one or more air intakes ports formed in the helmet, and which are sufficiently porous to allow adequate air passage therethrough. Each filter is coated with a benign adsorption substance, such as vegetable oil, which captures the particles and prevents them from passing through to the rider, and which does not clog the filter pores. A filter with these characteristics also may be used in other applications, such as with air conditioners, carpentry dusk masks, and the like.

### BACKGROUND OF THE INVENTION

1. Field of the Invention

The present invention relates to a helmet. More particularly, the present invention relates to a protective helmet for use by a rider of an open-air vehicle, such as a motorcycle or an all-terrain vehicle. Still more particularly, the present invention relates to a protective helmet having a porous filter which adheres particles of dirt, dust, and other debris to prevent those particles from reaching the rider's face.

2. Description of the Prior Art

Open-air vehicles, such as motorcycles and all-terrain vehicles, are immensely popular both in the United States and worldwide. One of the hazards associated with riding vehicles of this kind includes the heightened risk that the rider will suffer a head injury in an accident. To reduce this risk, most riders of these vehicles choose, or are required, to wear a helmet which cushions the head when the helmet strikes a hard surface, such as asphalt or gravel. Another hazard associated with these vehicles is that they leave their riders exposed to dirt, dust, and similar debris that are typically present in the air wherever these vehicles are driven. These materials can pass into a rider's respiratory system through the nose and mouth and cause the rider to cough, choke or otherwise be discomforted. These materials also can get into the rider's eyes and cause irritation or temporary blinding. Whenever these materials adversely affect a rider, the riding experience is sure to be tarnished or spoiled altogether.

A helmet which is not only protective, but which is also specifically designed to prevent dirt, dust, and similar debris from reaching the face would be convenient to riders. Existing protective helmets, however, are not optimally designed to block such materials from reaching the face. Some helmets, for example, do not include a shield or any other device which covers the face. Helmets of this kind provide absolutely no protection from these materials. Other helmets have a shield, such as a piece of transparent plastic which covers a face opening in the helmet, and those helmets typically are equipped with air ports through which air from outside the helmet passes to the rider. These air ports are not optimal, however, because they are not impervious to small particles of dirt, dust and other debris. Therefore, those who wear these helmets are not optimally protected from inhaling these materials or from having them get into their eyes.

In an attempt to gain more protection from these materials than existing helmets are capable of providing, some riders cover their mouth and nose with a bandanna or similar piece of textile material. This is largely ineffective, however, because wearing the bandanna so close to the face promotes heat localization around the mouth and nose and retards the free flow air to the mouth and nose, each of which makes breathing difficult. Worse, breathing increasingly becomes more difficult as the bandanna becomes more and more clogged by the debris material it captures.

What is needed therefore is a protective helmet that is equipped with an air port or ports having a filtering device that prevents dirt, dust, and similar debris from reaching a rider's face while riding. Further, the filtering device should not substantially diminish the rider's access to fresh air or in any other way cause discomfort to the rider, such as causing the rider to experience elevated heat localization around the mouth and nose.

### SUMMARY OF THE INVENTION

It is an object of the present invention to provide a protective helmet which substantially limits materials such as dirt, dust and similar debris from reaching the mouth and nose of the individual wearing the helmet while riding an open-air vehicle, such as a motorcycle or all-terrain vehicle. The helmet wearer is protected from these materials by a filter that forms a removable part of the helmet. Specifically, this filter covers one or more air intake ports forming part of the helmet. The air intake ports may be located in the lower portion of the helmet, and more specifically the region of the helmet near the mouth and nose of the wearer. The filter is arranged to be sufficiently porous to allow an adequate volume of air to flow therethrough to the wearer. The filter also is coated with a benign adsorption substance selected so that it does not clog the pores of the filter, and which serves to adsorb unwanted materials that otherwise would pass entirely through the air intake port and to the wearer. Since the benign adsorption substance does not clog the filter, it does not significantly restrict air flow through the filter.

It is yet another aspect of the present invention to allow air from outside the helmet to enter the helmet substantially only through its air intake ports. When the helmet is being properly worn, it is essentially airtight everywhere but at the air intake ports and possibly at an opening at the base of the helmet which encompasses the wearer's neck. However, some air may flow into the helmet through a vision port in the helmet to help cool the face of the wearer while riding. The helmet further may include diverting flaps which extend from the base of the helmet to the wearer's neck, and which serve to substantially divert air from flowing into the opening between the wearer's neck region and the helmet.

The details of one or more examples related to the invention are set forth in the accompanying drawings and the description below. Other features, objects, and advantages of the invention will be apparent from the description and the drawings.

### BRIEF DESCRIPTION OF THE DRAWINGS

FIG. 1 is a perspective side view of a preferred embodiment of the helmet of the present invention.

FIG. 2 is a perspective bottom view of inside the upper portion of the helmet of the present invention.

FIG. 3 is an interior rear view of the jaw portion of the helmet showing the air intake port and removable filter of the present invention.

FIG. 4 is a side view of a filter of the present invention, which is insertable into an air conditioning unit.

### DETAILED DESCRIPTION OF THE PREFERRED EMBODIMENT

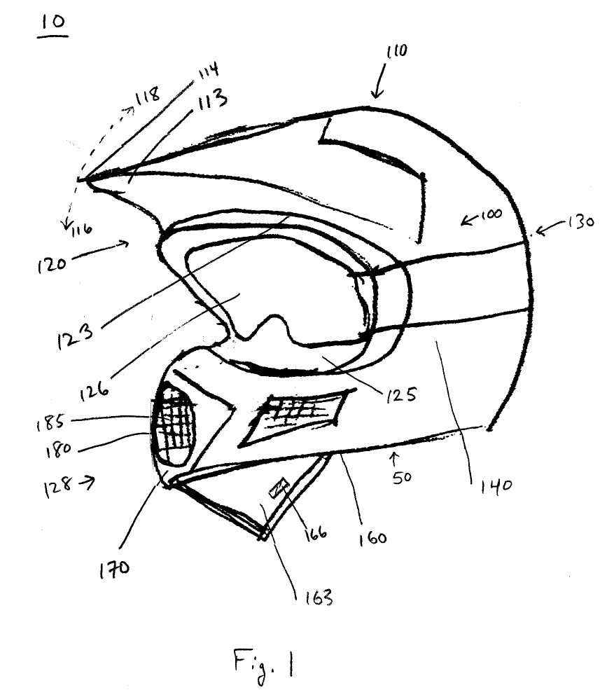

The present invention is a protective helmet for a human head having a treated filter which prevents dirt, dust and similar debris from reaching the mouth and nose of the helmet wearer. Referring to FIGS. 1 and 2, the helmet 10 includes a shell 100 and an inner liner 105. The shell 100 is formed from a contiguous material and includes a crown region 110, a front region 120, a back region 130, a first side region 140, a second side region 150, and lower edge surface 160. The helmet 10 has an opening 50 large enough for a human head to pass therethrough. Proper positioning of the helmet 10 on a head includes passing the head into the opening 50 such that the head resides in head chamber 75.

The helmet 10 also includes an optional visor 113. The visor 113 may be integral with the helmet 10, or it may be a separate piece that is fixed to the helmet 10 such that it is not adjustable, or it may be adjustably connected to the helmet 10. In a preferred embodiment of the present invention, the visor 113 is included as an adjustable part of the helmet 10 and extends outwardly from the crown region 110 and past the front region 120. In this arrangement, the visor 113 is rotatably fixed to the helmet 10 at first side region 140 and at second side region 150 such that brim 114 of the visor 113 may be moved to or near position 116 and to or near position 118 about a fixed axis.

A vision port 123 is included at the midsection of the front region 120. A transparent deflecting device 126 is detachably connected to the vision port 123. This connection substantially prevents air and materials such as dirt, dust, and similar debris from entering the head chamber 75 through the vision port 123. This connection, however, may allow some air to enter the helmet 10 when it is being worn while riding. Any air which passes through this connection would be useful for cooling the face of the rider, but the amount should be limited to ensure that minimal debris contacts the face.

The front region 120 optionally includes one or more diverting flaps 163 located at, and extending away from, the base 128 of the front region 120 of the shell 100. When the helmet 10 is being properly worn, the diverting flaps 163 extend from the base 128 and toward the upper torso of the wearer. A fastening device 166 is connected to each diverting flap 163. The fastening device 166 may be used to reversibly fasten each diverting flap 163 to the rider. For example, the fastening device 166 may fasten the diverting flap 163 at a position which is just below the rider's neck at the chest region of the rider's upper torso.

The helmet 10 further includes a jaw portion 170, which is located at the base 128 of front region 120. In a preferred embodiment of the present invention, the jaw portion 170 extends outwardly from the base 128 of the front region 120. In an alternative embodiment of the present invention, the jaw portion 170 does not extend outwardly from the base 128 of the front region 120.

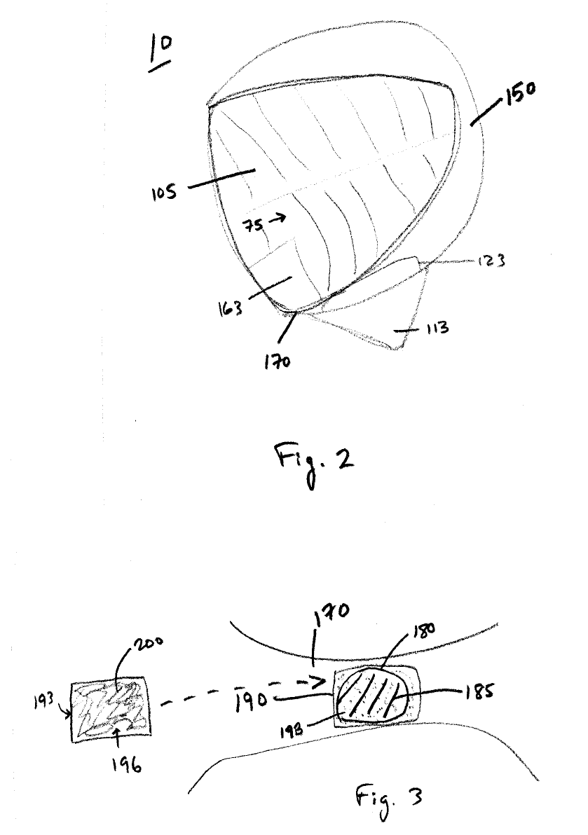

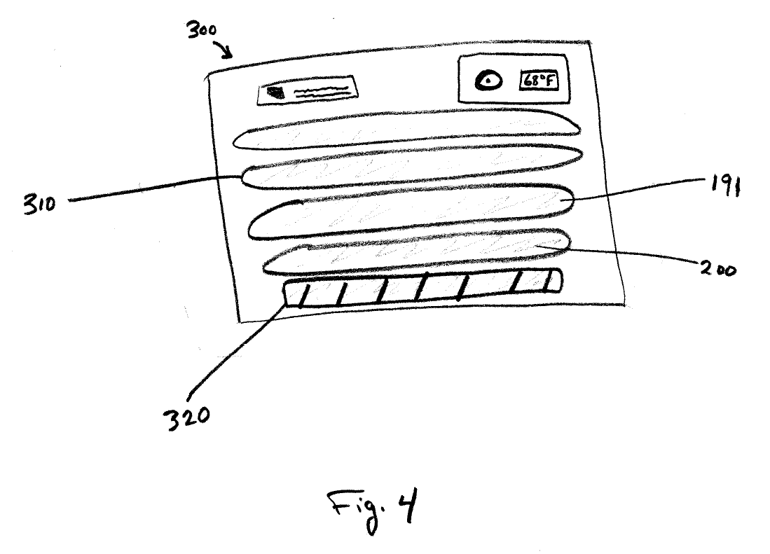

In all embodiments of the present invention, the jaw portion 170 includes one or more air intake ports 180 through which air may pass. Each air intake port 180 includes a plurality of slats 185 which help direct air flow into the helmet 10. The slats 185 may be fixed or they may be movable. In one embodiment of the present invention, which is shown in FIG. 1, the helmet 10 has two air intake ports 180, one of which is located at central region 173 of the jaw portion 170, and the other of which is located at first side region 176 of the jaw portion 170. In an alternative embodiment of the present invention, which is shown in FIG. 3, the helmet 10 has two air intake ports 180, one of which is located at first side region 176, and the other of which is located at second side region 178. It is to be understood, however, that the present invention is not limited to these specific embodiments. Therefore, the present invention may contain any number of air intake ports 180, and each air intake port 180 may be positioned at any location on the jaw portion 170.

As shown in FIG. 3, the helmet 10 further includes one removable filter 190 for each air intake port 180. Each filter 190 is removably inserted into its own air intake port 180. Each removable filter 190 has an internal side 193 and an external side 196. The internal side 193 faces the head chamber 75 and the external side 196 is oriented such that it faces away from the head chamber 75 and toward the slats 185. In this arrangement, the external side 196 faces away from the rider's mouth and nose and the internal side 193 faces toward the rider's mouth and nose while the helmet 10 is being worn.

The removable filter 190 prevents particles of dirt, dust and similar debris from reaching the rider's mouth and nose while the helmet 10 is being worn but without compromise to airflow. That is, the filter 190 is sufficiently porous to allow enough air volume to flow to the rider throughout the ride. Whereas larger pores would ordinarily allow dirt and dust particles to pass through to the rider, the filter 190 of the present invention is treated with a benign adsorption substance 200 which adsorbs dirt and dust particles before they can pass through the filter 190, but is not harmful or otherwise irritating to humans, and which does not compromise the porosity of the filter 190. The benign adsorption substance 200 may be a single substance or it may be a mixture of two or more substances. Further, the benign adsorption substance 200 may be applied to only the external side 196 of the filter 190, or it may be applied to the entire filter 190, including being applied on both the internal side 193 and the external side 196. In a preferred embodiment of the present invention, the benign adsorption substance 200 is vegetable oil. Vegetable oil will not clog the filter pores, it adsorbs dirt and dust well, and it is benign to humans. It is to be understood, however, that the benign adsorption substance 200 is not limited to being vegetable oil. For example, the benign adsorption substance 200 may be mineral oil, lanolin, or any other substance that is not precluded by the aforementioned limitations.

Since the removable filter 190 accumulates dirt and dust, it may be washable, and therefore, reusable. It is to be understood, however, that the removable filter 190 need not be washable and reusable, as single use filters 190 also could be included as part of the helmet 10. In a preferred embodiment of the present invention, the removable filter 190 is resistant to both water and detergent degradation, and therefore may be washed by using a washing machine or it may be washed by hand. After washing, the user may recoat the filter 190 with the benign adsorption substance 200 and reinsert the filter 190 into the air intake port 180.

As noted, the material from which the removable filter 190 is constructed, as treated with the benign adsorption substance 200, must be sufficiently porous to allow air to pass therethrough. Also as noted, where the removable filter 190 is washable, the removable filter 190 must be able to withstand exposure to detergent, hot water and the rigors of mechanical washing, either when done by a machine or by the human hand. Further, the integrity of the material chosen must not be substantially compromised by the benign adsorption substance 200, and must be capable of being coated essentially evenly by the benign adsorption substance 200. Exemplary materials which therefore may be used to construct the removable filter 190 include foam materials. Exemplary foams include polyethylene and polyurethane, which may be made porous, are able to withstand detergents, and are capable of being evenly coated with various substances which may be used as the benign adsorption substance 200. It is to be understood, however, that the removable filter 190 is not limited to being a polyethylene foam, a polyurethane foam, or any other kind of foam. For example, the removable filter 190 may be any other synthetic material, such as polyester or rayon, or it may be any natural material, such as cotton, that is not precluded by the above mentioned limitations.

Like the removable filter 190, the transparent deflecting device 126 through which the rider looks also helps to prevent particles of dirt, dust and similar debris from reaching the rider's face, and which serves to direct air outside the helmet to the air intake ports 180. Since the rider must look through the deflecting device 126 to see outside the helmet 10, the material from which the deflecting device 126 not only must be transparent, but it also must not substantially distort or otherwise impair the rider's vision. Exemplary materials from which the deflecting device 126 may be formed include, but are not limited to being, acrylic and polycarbonate.

Further, the transparent deflecting device 126 may take any of a number of forms. For example, the deflecting device 126 may be a pair of goggles. When goggles are included, the goggles are connected to the helmet 10 by a connecting member 125, as shown in FIG. 1, such that the entire perimeter of the interface between the goggles and the vision port 123 is substantially sealed. This seal serves to make the vision port 123 substantially impervious to air, dirt, dust and similar debris. This connection does not have to establish a complete seal, so it allows some air to enter the helmet 10 to cool the face of the wearer when it is being worn while riding. The connecting member 125 may be, but is not limited to being, a foam, rubber or plastic gasket.

As another example, the deflecting device 126 may be a continuous substrate, such as plastic, which covers the entire vision port. Where the deflecting device 126 is a continuous substrate, it may cover the vision port 123 such that its outside surface, which is namely the surface which faces away from the head chamber 75, is substantially flush with the shell 100.

The helmet 10 is able to withstand substantial collision while the helmet 10 is being worn, such as when the helmet 10 strikes a hard surface, and may be of any type of helmet that is generally available to protect riders of open-air vehicles. In a preferred embodiment of the present invention, the material used to form the shell 100 and the optional visor 113 is a hard plastic. An exemplary hard plastic is acrylonitrile butadiene styrene. Further, the hard plastic may or may not be reinforced with a secondary material or materials, such as kevlar and/or carbon fiber. In alternative embodiments of the present invention, the shell 100 and the optional visor 113 are formed of any material, such as a plastic composite or a metal or metal alloy, which one ordinarily skilled in the art of protective helmet manufacturing would recognize as being suitable for protecting the head.

The inner liner 105 provides a comfortable cushion barrier between the rigid shell 100 and the rider's head, and may be of any type of liner that is generally included as part of helmets which protect riders of open-air vehicles. The cushioned nature of the inner liner 105 also allows the helmet 10 to conform to, and to snuggly fit, heads of differing circumferences. In a preferred embodiment of the present invention, the inner liner 105 is soft but thick, and is made of expanded foam. One exemplary expanded foam is polypropylene, and another is polystyrene. The inner liner 105, however, is not limited to being an expanded foam, but may be an material or combination of materials that one ordinarily skilled in the art of protective helmet manufacturing would recognize as being comfortable when held against the head and which would cushion the head whenever the helmet 10 strikes a hard surface.

A filter having the characteristics of adhering dirt and dust particles while also being benign for human breathing and allowing sufficient air passage therethrough may be used in other applications. For example, as shown in FIG. 4, a filter 191 may be included as part of an air conditioning device 300. The filter 191 specifically may be included at a surface of the air conditioning device 300 having an air intake port or ports 310 to prevent particles of dirt, dust and similar debris in the ambient air from being drawn into the air conditioning device 300, and having an air outflow port or ports 320 to prevent such particles from being passed out of the air conditioning device 300. By preventing these particles from passing into and out of the air conditioning device 300, the filter 191 helps keep other components of the device 300, such as its compressor and fan, clean, thereby extending the life of the air conditioning unit and allowing it to run at maximum efficiency, and thereby preventing these particles from being dispersed into the ambient air and therefore from being inhaled by nearby humans.

Other examples of applications of a filter having such characteristics are dust masks, such as those typically used by carpenters and building constructors during the course of their work. Where a dust mask includes the filter having the aforementioned characteristics, the filter may form all or only part of the portion of the mask which covers the nose and mouth.

A filter having such characteristics also may be included as part of a filter kit which does not include a device for use with the filter, such as a helmet, air conditioning unit, or dust mask. For example, the filter, or multiple filters, in single-use, disposable form could be made available as part of a replacement kit to consumers of such devices. This would enable these consumers to quickly and easily replace the filter or filters that are supplied with the device when those filters become dirtied, thereby allowing those consumers to avoid having to clean them.

As another example, the filter, or multiple filters, may be included as part of a modification kit which may be used to modify an existing helmet, air conditioning unit, or other device that is not specifically designed to accommodate the filter, to be used with the filter. In this arrangement, the filter modification kit may further include other components, such as vegetable oil, adhesive devices, and filter trimming devices, which may be used to prepare the filter and to facilitate the adaptation of the helmet, air conditioning unit, or other device to accommodate the filter.

As yet another example, the filter, or multiple filters, may be included as part of a kit which may be used to modify an existing helmet to be substantially impervious to dirt, dust and other debris. For example, as described above, the kit may include other components which may be used to prepare the filter and to facilitate the adaptation of the helmet to accommodate the filter, and further include one or more component which may be used to substantially seal or block other openings of the helmet, such as the vision port or the opening of the head chamber. Therefore, the kit may include, but is not limited to including, the connecting member 125 and/or the diverting flap 163 of the present invention.

A number of examples to help illustrate the invention have been described. Nevertheless, it will be understood that various modifications may be made without departing from the spirit and scope of the invention. Accordingly, other embodiments are within the scope of the claims appended hereto.

What is claimed is:

1. A helmet, comprising:
a. a front region having one or more air intake ports through which air may pass; and
b. a filter in each of the one or more intake ports, wherein the filter is treated with a benign adsorption substance which is capable of adhering small particles, and wherein the treated filter is sufficiently porous to allow air to flow therethrough.

2. The helmet of claim 1 wherein the filter is formed from a foam material.

3. The helmet of claim 1 wherein the foam material is selected from the group consisting of polyethylene and polyurethane.

4. The helmet of claim 1 wherein the benign adsorption substance is vegetable oil.

5. The helmet of claim 1 wherein the benign adsorption substance is a mixture of two or more substances.

6. The helmet of claim 1 wherein the front region forms a jaw portion and the one or more air intake ports are located in the jaw portion.

7. The helmet of claim 1 further comprising one or more diverting flaps.

8. The helmet of claim 7 wherein each of the one or more diverting flaps has a fastening device for reversibly affixing the one or more diverting flaps to a substrate which is not part of the helmet.

9. The helmet of claim 1 wherein at least one of the one or more intake ports includes slats.

10. The helmet of claim 9 wherein the slats are movable.

11. The helmet of claim 1 wherein the helmet further includes a vision port and a deflecting device, and wherein the deflecting device is connected to the vision port.

12. The helmet of Claim 11 wherein the connection between the deflecting device and the vision port is sufficiently sealed to substantially prevent air from entering the helmet through the vision port.

13. The helmet of claim 11 wherein the connection between the deflecting device and the vision port is made by using a connecting member.

14. The helmet of claim 13 wherein the connecting member is a foam or rubber gasket.

15. The helmet of claim 11 wherein the deflecting device is a pair of goggles.

16. A filter, comprising:
a. a first side and an second side; and
b. a benign adsorption substance which is capable of adsorbing small particles, wherein the benign adsorption substance is coated on at least one of the first side and the second side, wherein the treated filter is sufficiently porous to allow air to flow therethrough.

17. The filter of claim 16 wherein the benign adsorption substance is vegetable oil.

18. The filter of claim 16 wherein the filter is included as part of an air conditioning device.

19. The filter of claim 16 wherein the filter is included as part of a dust mask.

20. The filter of claim 16 wherein the filter is included as part of a kit.
